(19) United States
(12) Patent Application Publication
(10) Pub. No.: US 2007/0201154 A1
(43) Pub. Date: Aug. 30, 2007

(54) Recording-medium inspection apparatus and method

(75) Inventor: Masahiro Ozeki, Kawasaki (JP)

Correspondence Address: ARMSTRONG, KRATZ, QUINTOS, HANSON & BROOKS, LLP;KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/452,242

(22) Filed: Jun. 14, 2006

(30) Foreign Application Priority Data
Feb. 22, 2006 (JP) 2006-46023

(51) Int. Cl. G11B 5/02

(52) U.S. Cl. 360/25

(57) ABSTRACT

A recording-medium inspection apparatus checks whether a protrusion provided on a recording medium to be inspected has a height larger than a predetermined height by detecting a contact between the protrusion and a head slider by a sensor while the head slider is flying above the rotating recording medium. The inspection apparatus includes an output-value obtaining means for obtaining an output value from the sensor when the head slider comes into contact with a protrusion having the predetermined height and provided on a reference recording medium, a flying-height adjusting means for adjusting a flying height of the head slider by changing a voltage applied between the head slider and the reference recording medium on the basis of the obtained output value, and a checking means for checking whether the recording medium is good or defective while the head slider is placed at the adjusted flying height.

### BACKGROUND OF THE INVENTION

1. Field of the Invention

The present invention relates to a recording-medium inspection apparatus and a recording-medium inspection method that check whether a protrusion on a recording medium serving as a surface defect has a height larger than a predetermined height.

2. Description of the Related Art

In a magnetic storage apparatus, information is recorded and reproduced on and from a magnetic recording medium while a flying head slider is positioned above a recording/reproducing track by rotating the magnetic recording medium.

This magnetic storage apparatus includes a head gimbal assembly. The head gimbal assembly includes a head slider having electromagnetic transducers, a gimbal on which the head slider is mounted, a suspension on which the gimbal is mounted, and a head arm that supports the suspension.

Three forces act on the head slider. A first force is a load applied by the suspension. Second and third forces are a positive pressure and a negative pressure that are generated when an air flow produced by the rotation of a magnetic recording medium passes through a rail on an ABS (air bearing surface) of the head slider facing the magnetic recording medium. The positive pressure separates the head slider from the magnetic recording medium, and the negative pressure attracts the head slider toward the magnetic recording medium.

Recording and reproduction are performed in a state in which the head slider is positioned at a predetermined track position and at a fixed flying height that is ensured by the balance among the three forces.

In this magnetic storage apparatus, when an abnormal protrusion or a foreign substance having a height larger than the flying height of the head slider is provided on the magnetic recording medium, the head slider flying above the magnetic recording medium comes into contact the protrusion or the foreign substance. As a result, the surface of the magnetic recording medium and the head slider are damaged, and this causes errors in data recording and reproduction.

For this reason, an inspection is performed in the last production process of the magnetic recording medium in order to assure smoothness of the surface of the magnetic recording medium.

The inspection is conducted in the following procedure.

First, an inspection head slider is caused to fly above a surface of a magnetic recording medium at a predetermined flying height. The lower limit of the height at which the inspection head slider does not come into contact with a protrusion of the magnetic recording medium is called a guaranteed flying height (hereinafter referred to as a glide height).

By an air flow produced by the rotation of the magnetic recording medium, the inspection head slider is placed in a flying position such that a first end serving as an inflow end of the air flow is high and a second end serving as an outflow end is low.

Therefore, the second end of the head slider facing the magnetic recording medium is at the lowest position. The distance between the second end and the surface of the magnetic recording medium corresponds to the glide height.

When the height of the protrusion on the surface of the magnetic recording medium is larger than the glide height, the inspection head slider comes into contact with the protrusion, and a shock wave produced by the contact is transmitted to a vibration sensor disposed on an upper surface or a side face of the inspection head slider. A voltage is induced by the vibration sensor, and is output as an output signal.

When an output detector connected to the vibration sensor detects an output signal that is larger than a predetermined threshold value, it determines that the magnetic recording medium is defective, and produces an error display.

The threshold value is measured beforehand by using a reference magnetic recording medium on which a protrusion having a predetermined glide height is provided.

More specifically, the threshold value is obtained by rotating the reference magnetic recording medium and measuring an output signal produced when the inspection head slider flying at the predetermined glide height comes into contact with a protrusion on the reference magnetic recording medium.

Even when the magnetic recording medium has only one defect described above, it is normally disposed of as a defective.

In order to precisely detect the protrusion on the reference magnetic recording medium, the head gimbal assembly needs to be designed so that the head slider can fly above the magnetic recording medium at the predetermined height.

That is, the head gimbal assembly is required to be designed to output a predetermined signal when the head slider comes into contact with the protrusion on the reference magnetic recording medium.

For that purpose, it is necessary to perform simulations while changing the rail shape of the head slider, the load applied to the head slider via the suspension, and the flying pitch angle of the head slider in the head gimbal assembly, and to make several prototypes of head gimbal assemblies.

By thus making the prototypes, the predetermined flying height of the head slider above the reference magnetic recording medium can be achieved.

### SUMMARY OF THE INVENTION

A recording-medium inspection apparatus according to an aspect of the present invention checks whether a protrusion provided on a surface of a recording medium to be inspected has a height larger than a predetermined height by detecting a contact between the protrusion and a head slider by means of a sensor while the recording medium is rotating and the head slider is flying above the rotating recording medium. The recording-medium inspection apparatus includes an output-value obtaining means for obtaining an output value from the sensor when the head slider comes into contact with a protrusion having the predetermined height and provided on a reference recording medium; a flying-height adjusting means for adjusting a flying height of the head slider to an inspection flying height by changing a voltage applied between the head slider and the reference recording medium on the basis of the obtained output value; and a checking means for checking whether the recording medium to be inspected is good or defective while the head slider is placed at the inspection flying height.

### BRIEF DESCRIPTION OF THE DRAWINGS

FIG. 1 is a structural view of a magnetic-recording-medium inspection apparatus according to an embodiment of the present invention;

FIG. 2 is an explanatory view of the principal part of the magnetic-recording-medium inspection apparatus;

FIG. 3 is a flowchart showing an inspection procedure performed by the magnetic-recording-medium inspection apparatus; and

FIG. 4 is an explanatory view showing the relationship between the flying height and the voltage.

### DESCRIPTION OF THE PREFERRED EMBODIMENTS

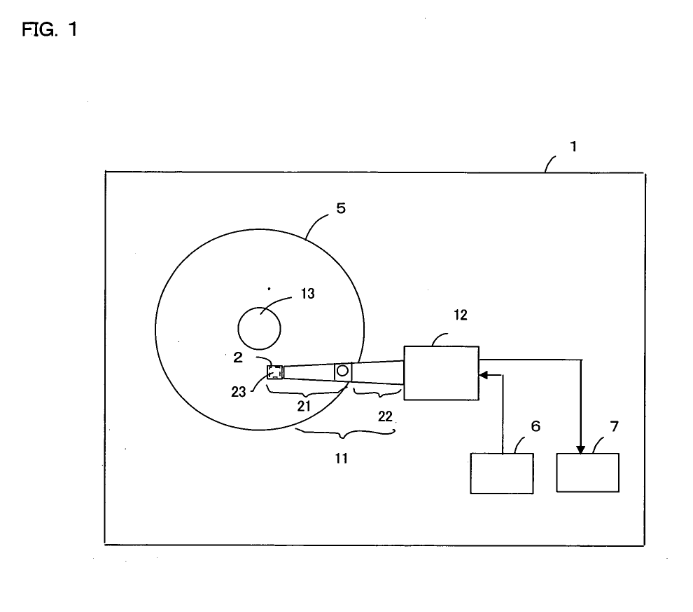

FIG. 1 is a structural view of a magnetic-recording-medium inspection apparatus according to an embodiment of the present invention.

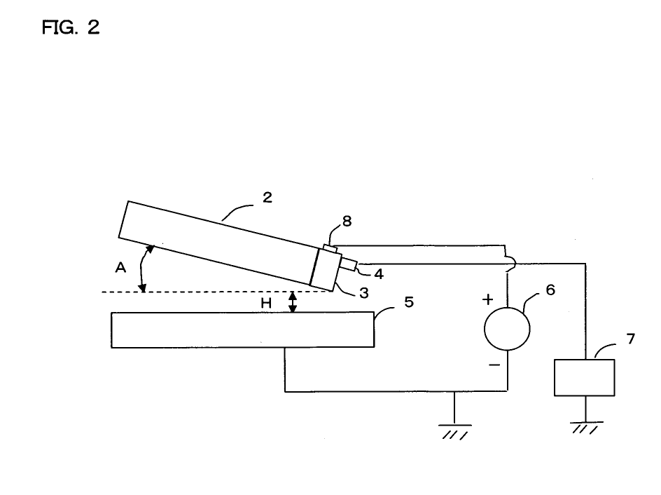

A magnetic-recording-medium inspection apparatus 1 of this embodiment includes a head gimbal assembly 11 in which a head slider 2 is mounted, a driving unit 12 for driving the head gimbal assembly 11, a magnetic recording medium 5, a spindle motor 13 for rotating the magnetic recording medium 5, a power supply 6 for applying a voltage between the head slider 2 and the magnetic recording medium 5, an output detector 7 for detecting the output from a vibration sensor 4 (FIG. 2) mounted in the head slider 2, and a controller (not shown) for controlling the entire apparatus.

The head gimbal assembly 11 includes a suspension 21 and a head arm 22 that supports the suspension 21. A gimbal 23 is mounted at the leading end of the suspension 21, and the head slider 2 is fixed to the gimbal 23. The head arm 22 is connected to the driving unit 12.

According to a command from the controller, the driving unit 12 is driven to move the head gimbal assembly 11, and the head slider 2 is thereby moved.

The controller includes a circuit for controlling the movement of the head slider 2, a circuit for controlling the rotation of the magnetic recording medium 5, and the power supply 6.

The flying height of the head slider 2 from the magnetic recording medium 5 is determined by, for example, the rotation speed of the spindle motor 13, positive and negative pressures in accordance with the rail shape of the head slider 2, the press-down force given by the load from the suspension 21, the flying pitch angle, and the electrostatic attracting force produced by the voltage.

For this reason, a simulation of the head gimbal assembly 11 is performed beforehand in order to obtain a predetermined flying height. The head gimbal assembly 11 is produced according to the simulation result.

During production, the flying height is set to be larger than the glide height. This is because the flying height is adjusted by being sequentially decreased by the application of the voltage.

The produced head gimbal assembly 11 is mounted in the magnetic-recording-medium inspection apparatus 1. The flying height is then adjusted to remove mounting errors and production errors of the head gimbal assembly 11.

For the adjustment, a voltage is applied between the magnetic recording medium 5 and the head slider 2. By the application of the voltage, a potential difference is formed between the magnetic recording medium 5 and the head slider 2, and an electrostatic attracting force is produced in accordance with the potential difference.

The flying height and flying pitch angle of the head slider 2 can be adjusted by changing the voltage to be applied. The flying pitch angle automatically varies as the flying height is adjusted. When the flying pitch angle increases, slipping of the head slider 2 at a contact with a protrusion on the magnetic recording medium 5 is reduced, and detection of the contact becomes easy. Therefore, the accuracy in detecting the protrusion is increased.

FIG. 2 is an explanatory view showing the principal part of the magnetic-recording-medium inspection apparatus 1.

An insulating film 3 is provided on the head slider 2. The insulating film 3 is made of a material, such as alumina, having a dielectric constant higher than that of the material of the head slider 2 such as AlTiC. A connecting portion 8 is provided on the insulating film 3 so as to be connected to the power supply 6. The insulating film 3 is disposed at an end of the head slider 2 from which the air flow goes out.

The insulating film 3 may be provided on the entire ABS of the head slider 2. The head slider 2 may be made of a material having a high dielectric constant.

The flying pitch angle means the angle formed between the head slider 2 and the magnetic recording medium 5, and is represented by A in FIG. 2.

The flying height means the distance between the head slider 2 and the magnetic recording medium 5, and is represented by H in FIG. 2.

The following connections are made in order to apply the voltage between the head slider 2 and the magnetic recording medium 5. That is, the connecting portion 8 of the head slider 2 is connected to a plus terminal of the power supply 6 provided in the controller via the suspension 21. A minus terminal of the power supply 6 is grounded.

A housing of the spindle motor 13 in which the spindle motor 13 and the magnetic recording medium 5 are in contact with each other is made of a conductive material, and is grounded.

Even when the insulating film 3 of the head slider 2 comes into contact with a protrusion on the magnetic recording medium 5, it is made of an insulating material, and therefore, a current does not flow. Consequently, a current breakdown does not occur in the head slider 2 and so on.

The vibration sensor 4 is fixed on a side face of the head slider 2. The output of the vibration sensor 4 is transmitted to the output detector 7.

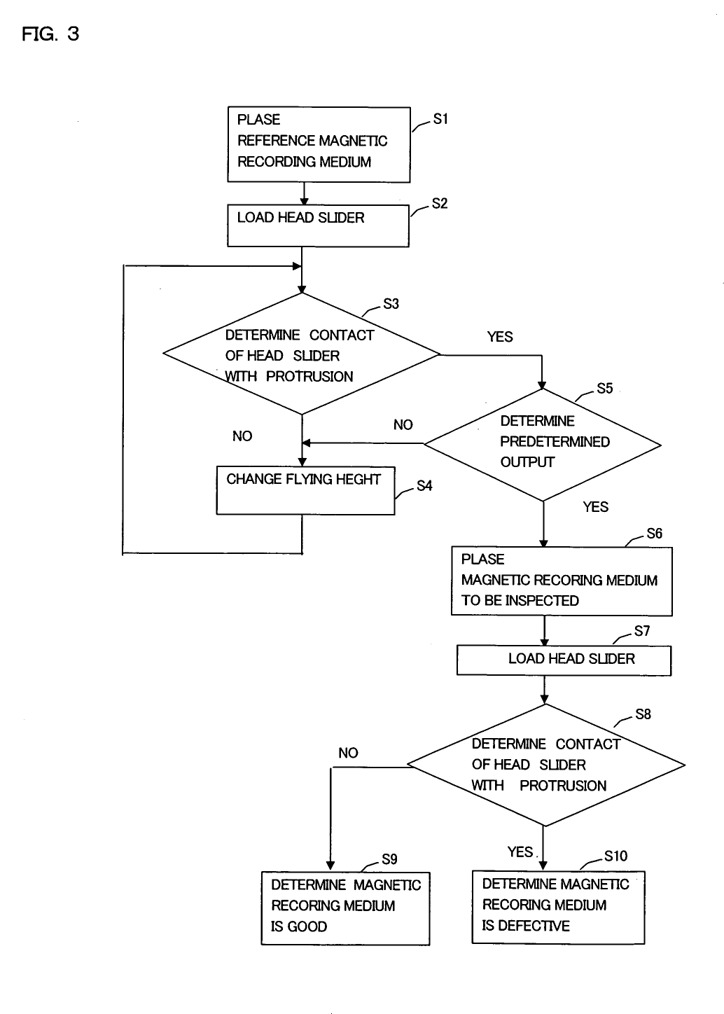

FIG. 3 is a flowchart showing the inspection procedure performed by the magnetic-recording-medium inspection apparatus 1.

First, a new head gimbal assembly 11 is mounted in the magnetic-recording-medium inspection apparatus 1 in preparation for an inspection.

The inspection is performed in the following procedure.

First, a reference magnetic recording medium including a protrusion having a predetermined glide height is placed in the magnetic-recording-medium inspection apparatus 1 (Step S1).

Subsequently, the head slider 2 is loaded above the reference magnetic recording medium (Step S2).

It is determined whether a contact of the head slider 2 with a protrusion on the reference magnetic recording medium is detected by the vibration sensor 4 (Step S3).

When the contact is not detected, the flying height is changed (Step S4), and Step S3 is performed again.

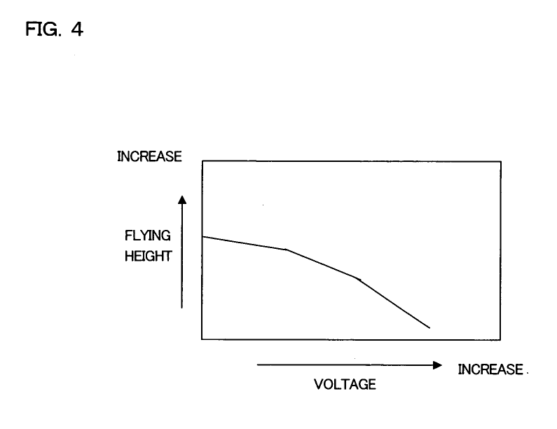

FIG. 4 shows the relationship between the flying height and the voltage.

As shown in FIG. 4, the flying height decreases when the applied voltage increases, and increases when the applied voltage decreases.

A plurality of voltages corresponding to the flying heights are stored beforehand in a memory of the controller.

The flying height is changed on the basis of this relationship between the flying height and the voltage.

That is, until a contact is detected, the voltage is applied while being sequentially changed so that the flying height H between the head slider 2 and the reference magnetic recording medium sequentially decreases.

When the head slider 2 comes into contact with the protrusion, it is determined whether a predetermined output is produced (Step S5). When the predetermined output is not produced, Step S4 is performed again to change the flying height. When the predetermined output is produced, the head slider 2 is unloaded, the reference magnetic recording medium is removed, and a magnetic recording medium 5 to be inspected is placed in the magnetic-recording-medium inspection apparatus 1 (Step S6), and the head slider 2 is loaded (Step S7).

Then, it is determined whether a contact of the head slider 2 with a protrusion of the magnetic recording medium 5 is detected by the vibration sensor 4 (Step S8).

When the contact is not detected by the vibration sensor 4, it is determined that the magnetic recording medium 5 is good (Step S9). When the contact is detected by the vibration sensor 4, it is determined that the magnetic recording medium 5 is defective (Step S10).

In this way, the inspection for detecting the protrusion on the magnetic recording medium 5 can be easily performed by controlling the flying height of the head slider 2 above the magnetic recording medium 5.

By using this inspection method, the number of design cycles of the head gimbal assembly 11 can be made smaller than before, that is, can be reduced from four or five to one or two.

Since the flying height can be decreased without changing the spring pressure of the suspension 21 and the rail shape, the magnetic recording medium 5 will not be damaged.

In addition, since the sensitivity of the head gimbal assembly 11 can be adjusted after the head gimbal assembly 11 is mounted in the inspection apparatus 1, a yield of approximately 100% can be achieved.

What is claimed is:

1. A recording-medium inspection apparatus for checking whether a protrusion provided on a surface of a recording medium to be inspected has a height larger than a predetermined height by detecting a contact between the protrusion and a head slider flying above the recording medium by means of a sensor, the recording-medium inspection apparatus comprising:
output-value obtaining means for obtaining an output value from the sensor upon the head slider coming into contact with a protrusion having the predetermined height, said protrusion being provided on a reference recording medium;
flying-height adjusting means for adjusting a flying height of the head slider to an inspection flying height by changing a voltage applied between the head slider and the reference recording medium on the basis of the obtained output value; and
checking means for checking whether the recording medium to be inspected is good or defective upon the head slider being placed at the inspection flying height.

2. The recording-medium inspection apparatus according to claim 1, wherein the flying-height adjusting means comprises:
output-value comparing means for comparing the obtained output value with a predetermined value; and
flying-height control means that sets the inspection flying height to the flying height provided when the obtained output value coincides with the predetermined value, and that changes the flying height by changing the voltage applied between the head slider and the reference recording medium when the obtained output value does not coincide with the predetermined value.

3. The recording-medium inspection apparatus according to claim 1, wherein an insulating layer having a dielectric constant higher than that of the head slider is provided on the head slider to apply the voltage to the head slider.

4. A recording-medium inspection method for checking whether a protrusion provided on a surface of a recording medium to be inspected has a height larger than a predetermined height by detecting a contact between the protrusion and a head slider flying above the recording medium by means of a sensor, the recording-medium inspection method comprising:
an output-value obtaining step of obtaining an output value from the sensor when the head slider comes into contact with a protrusion having the predetermined height, said protrusion being provided on a reference recording medium;
a flying-height adjusting step of adjusting a flying height of the head slider to an inspection flying height by changing a voltage applied between the head slider and the reference recording medium on the basis of the obtained output value; and
a checking step of checking whether the recording medium to be inspected is good or defective while the head slider is placed at the inspection flying height.

5. The recording-medium inspection method according to claim 4, wherein the flying-height adjusting step comprises:
an output-value comparing step of comparing the obtained output value with a predetermined value; and
a flying-height control step of setting the inspection flying height to the flying height provided when the obtained output value coincides with the predetermined value, and changing the flying height by changing the voltage applied between the head slider and the reference recording medium when the obtained output value does not coincide with the predetermined value.

6. A recording-medium inspection apparatus for checking whether a protrusion provided on a surface of a recording medium to be inspected has a height larger than a predetermined height by detecting a contact between the protrusion and a head slider flying above the recording medium by means of a sensor, the recording-medium inspection apparatus comprising:
a output-value obtaining unit for obtaining an output value from the sensor upon the head slider coming into contact with a protrusion having the predetermined height, said protrusion being provided on a reference recording medium;
a flying-height adjusting unit for adjusting a flying height of the head slider to an inspection flying height by changing a voltage applied between the head slider and the reference recording medium on the basis of the obtained output value; and
a checking unit for checking whether the recording medium to be inspected is good or defective upon the head slider being placed at the inspection flying height.

7. The recording-medium inspection apparatus according to claim 6, wherein the flying-height adjusting unit comprises:
a output-value comparing unit for comparing the obtained output value with a predetermined value; and
a flying-height control unit that sets the inspection flying height to the flying height provided when the obtained output value coincides with the predetermined value, and that changes the flying height by changing the voltage applied between the head slider and the reference recording medium when the obtained output value does not coincide with the predetermined value.

8. The recording-medium inspection apparatus according to claim 6, wherein an insulting layer having a dielectric constant higher than that of the head slider is provided on the head slider to apply the voltage to the head slider.
